(19) United States
(12) Patent Application Publication
(10) Pub. No.: US 2018/0079305 A1
(43) Pub. Date: Mar. 22, 2018

(54) GAUGE WITH ROTARY SELECTOR AND METHOD OF INSTALLING

(71) Applicant: MCNALLY ELECTRONICS INC., Zephyrhills, FL (US)

(72) Inventor: David P. Teichman, Zephyrhills, FL (US)

(21) Appl. No.: 15/268,857

(22) Filed: Sep. 19, 2016

(51) Int. Cl. B60K 37/02; G01D 13/02; G01D 13/22

(52) U.S. Cl. CPC B60K 37/02; G01D 13/02; B60K 2350/1064; B60K 2350/307; G01D 13/22

(57) ABSTRACT

A gauge is disclosed that includes a combination analog-digital instrument display with an analog dial and a digital display; and a rotary selector. The rotary selector defines a central aperture; frames the combination analog-digital instrument display such that both the analog dial and the digital display are simultaneously viewable through the central aperture; and is rotatable about the combination analog-digital instrument display such that at least one of a rotation and a depression of the rotary selector selects, as an input for the digital display, one of a plurality of vehicle sensors disposed within an automotive vehicle on which the gauge is mounted. Each of the plurality of vehicle sensors measures a different physical quantity associated with the automotive vehicle.

### FIELD OF THE INVENTION

The present invention relates generally to gauges, and, more particularly, relates to a combination analog-digital gauge with a rotary selector.

### BACKGROUND OF THE INVENTION

It is well-known that automotive vehicle owners/users often enjoy upgrading and personalizing their vehicles with after-market features, accessories, parts, sensors/meters, etc., such as, for example, turbochargers, superchargers, exhausts, suspension systems, and the like. Further, and related to such activities, users may desire to view sensor outputs/readouts that are not currently available on a vehicle manufacturer's instrument panel. For example, installing a turbocharger aftermarket may prompt the user to also install additional aftermarket sensors to measure particular temperature and pressure measurements for safety reasons.

In addition, users may desire the ability to view readouts for a multitude of electrical sensors that are typically installed by the manufacturer in modern day automotive vehicles. Such electrical sensors may be used only for internal vehicle purposes and/or dealer mechanic diagnostic tools. Stated another way, some electrical sensors within an automotive vehicle are not associated with a gauge on the instrument panel.

Many prior art gauges include a one-to-one ratio of one sensor readout-to-one gauge display, in which one physical quantity (e.g., rpm) is shown within one gauge window. Unfortunately such prior art gauges consume valuable instrument panel/dashboard space, which is undesirable. This is particularly troublesome for smaller vehicles with smaller dashboards (e.g., motorcycles, sports cars, etc.). With such prior art gauges, when users desire to view additional sensor readouts on the instrument panel, such additional gauge(s) are required to be squeezed into available space on the instrument panel and/or dashboard. This can be particularly challenging because there is a limited amount of space on the instrument panel and users may desire an aesthetic gauge layout that is not overly cluttered. Also, an overly cluttered dashboard area can be an unsafe distraction to drivers.

Existing gauges can generally be divided into four categories: 1) an analogue sensor with an analog display (e.g., needle pointer gauge), 2) a digital sensor with an analog display, 3) a digital sensor with a digital display, and 4) an analog sensor with a digital display. Generally, digital sensors are more commonly used today and are considered less expensive. On the other hand, analog displays are generally easier for the human eyes and brain to more quickly interpret. For this reason, aircraft cockpits are often equipped with digital sensor-analog display gauges, because pilots prefer the analog display, even though the underlying sensor is digital.

Most gauges do not provide a combination analog-and-digital display in a single gauge window. Further, existing gauges do not provide user-selectable sensor readouts through a rotary dial, as well as, a universal connector for easy installation.

Unfortunately, installation of aftermarket gauges is often complicated and requires the user to carefully connect individual wires/cables from the engine area to the dashboard. Incorrect installation can be hazardous to the user, as well as the vehicle, and/or result in an inoperable gauge. Further, such prior art methods of installation are relatively time-consuming and require a level of electrical skill that some users may not possess. Accordingly, such unskilled users may be required to either hire a skilled electrician/mechanic (increasing costs), or attempt the installation themselves, at their own risk.

Therefore, a need exists to overcome the problems with the prior art as discussed above.

### SUMMARY OF THE INVENTION

The invention provides a gauge with rotary selector and method of installing that overcomes the hereinafore-mentioned disadvantages of the heretofore-known devices and methods of this

With the foregoing and other objects in view, there is provided, in accordance with the invention, a rotary gauge including a combination analog-digital instrument display including an analog dial and a digital display; and a rotary selector: defining a central aperture; framing the combination analog-digital instrument display such that both the analog dial and the digital display are simultaneously viewable through the central aperture; and rotatable about the combination analog-digital instrument display such that at least one of a rotation and a depression of the rotary selector changes a physical quantity displayed on the digital display.

In accordance with another feature of the present invention, the rotation and the depression of the rotary selector selects, as an input for the digital display, one of a plurality of vehicle sensors disposed within an automotive vehicle and communicatively coupled to the gauge, each of the plurality of vehicle sensors measuring a different physical quantity associated with the automotive vehicle.

In accordance with a further feature, an embodiment of the present invention further includes a universal connector disposed on a rear face of the gauge and operably configured to electrically couple the gauge to each of the plurality of vehicle sensors disposed within the automotive vehicle.

In accordance with another feature of the present invention, the universal connector is formed as at least one of a male connector and a female connector.

In accordance with yet another feature of the present invention, the analog dial displays a physical quantity different from a physical quantity displayed by the digital display.

In accordance with another feature, an embodiment of the present invention includes an optical encoder actuated by the rotation and the depression of the rotary selector so as to allow a user to select one of a plurality of vehicle sensors as an input for the digital display.

In accordance with another feature, an embodiment of the present invention includes an outer housing that substantially encloses the combination analog-digital instrument display therein, the outer housing including the rotary selector.

In accordance with a further feature of the present invention, the analog dial includes fixed physical graduation markings and at least one rotatable physical pointer.

In accordance with yet another feature, an embodiment of the present invention includes a rotary gauge including a combination analog-digital instrument display including an analog dial and a digital display; a rotary selector defining a central aperture and framing the combination analog-digital instrument display such that both the analog dial and the digital display are simultaneously viewable through the central aperture; and a universal connector disposed on a rear face of the gauge and operably configured to electrically couple the gauge to each of a plurality of vehicle sensors disposed within an automotive vehicle.

In accordance with a further feature of the present invention, each of the plurality of vehicle sensors measures a different physical quantity associated with the automotive vehicle; and the rotary selector is rotatable about the combination analog-digital instrument display such that at least one of a rotation and a depression of the rotary selector selects, as an input for the digital display, one of the plurality of vehicle sensors.

In accordance with the present invention, a method of installing a gauge in an automotive vehicle includes providing, by a user, an automotive vehicle including a plurality of vehicle sensors; providing, by the user, a gauge with a combination analog-digital instrument display with an analog dial and a digital display, and a rotary selector defining a central aperture and framing the combination analog-digital instrument display such that both the analog dial and the digital display are simultaneously viewable through the central aperture; and coupling, by the user, the gauge to each of the plurality of vehicle sensors by plugging a vehicle connector into a universal connector disposed on a rear face of the gauge.

In accordance with another feature, an embodiment of the present invention also includes coupling, by the user, the gauge to at least one of a vehicle dashboard and an instrument panel of the automotive vehicle.

In accordance with yet another feature, an embodiment of the present invention includes rotating, by the user, the rotary selector about the combination analog-digital instrument display; and depressing, by the user, the rotary selector in an axial direction to select, as an input for the digital display, one of the plurality of vehicle sensors so that a first physical quantity measure by the one of the plurality of vehicle sensors is displayed on the digital display.

In accordance with a further feature of the present invention, an embodiment includes displaying, by the user, a second physical quantity different from the first physical quantity on the digital display by at least one of rotating and depressing the rotary selector to select a second one of the plurality of vehicle sensors that measures the second physical quantity.

In accordance with another feature, an embodiment of the present invention includes actuating, by the user, an optical encoder electro-mechanically coupled to the rotary selector so as to allow the user to select one of the plurality of vehicle sensors as the input for digital display.

In accordance with yet another feature, an embodiment of the present invention further includes coupling, by the user, the gauge to at least three vehicle sensors disposed within the automotive vehicle.

Although the invention is illustrated and described herein as embodied in a gauge with rotary selector and method of installing, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the analog pointer shaft extending from a rear of the gauge toward a front face of the gauge. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a front perspective view of an exemplary rotary gauge in accordance with an embodiment of the present invention;

FIG. 2 is a front elevational view of the rotary gauge of FIG. 1, in accordance with the present invention;

FIG. 3 is a schematic diagram of an automotive vehicle in accordance with an embodiment of the present invention;

FIGS. 4-7 are front elevational views of multiple instances of the rotary gauge of FIG. 1, illustrating user-selection of sensor outputs for a rotary selectable digital display, in accordance with an embodiment of the present invention;

FIG. 8 is a side elevational view of the rotary gauge of FIG. 1, in accordance with the present invention;

FIG. 9 is an exploded perspective view of the rotary gauge of FIG. 1, in accordance with an exemplary embodiment of the present invention;

FIG. 10 is a top plan view of the rotary gauge of FIG. 1, in accordance with the present invention;

FIG. 11 is a cross-sectional view of the rotary gauge of FIG. 1, in accordance with the present invention;

FIG. 12 is side cross-sectional view of the rotary gauge of FIG. 1, in accordance with the present invention;

FIG. 13 is a partial view of the rotary gauge of FIG. 1, illustrating a gear linkage system and a universal connector, in accordance with the present invention;

FIG. 14 is an enlarged view of the gear linkage system introduced in FIG. 13, in accordance with an embodiment of the present invention;

FIG. 15 is a partial view of the rotary gauge of FIG. 1, illustrating a face plate/light lens with an LED display and an engagement slot, in accordance with an embodiment of the present invention;

FIG. 16 is an enlarged view of the engagement slot introduced in FIG. 15, in accordance with an embodiment of the present invention;

FIG. 17 is a perspective view of a light disk of the rotary gauge of FIG. 1, in accordance with an embodiment of the present invention; and

FIG. 18 is a process flow chart illustrating use of the rotary gauge of FIG. 1, in accordance with an embodiment the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient gauge with a rotary selector knob for allowing user-selection of the images on the digital display. Embodiments of the invention provide for a combination analog-digital gauge that includes both an analog dial and a digital display that are both simultaneously viewable within the gauge. In addition, embodiments of the invention provide that the rotary selector knob frames both the analog dial and the digital display, and the rotary selector knob is rotatable about the analog dial-digital display. Further, in some embodiments, depression of the rotary selector knob in an axial direction may actuate an optical encoder that selects, as an input for the digital display, one of a plurality of vehicle sensors disposed within the vehicle. Such vehicle sensors may measure different physical quantities associated with the automotive vehicle (e.g., pressure, temperature, speed, acceleration, distance, etc.). In yet further embodiments, the gauge includes a universal connector disposed on a rear face of the gauge that allows users to more conveniently and safely electrically couple the gauge to the vehicle sensors in a single step (e.g., a snap connector, male-female connector, or other friction-fit type connector that easily snaps or connects to a mating connector coupled to a vehicle sensor). In yet another embodiment, the gauge is entirely sealed within its housing, with the exception of the opening for the universal connector.

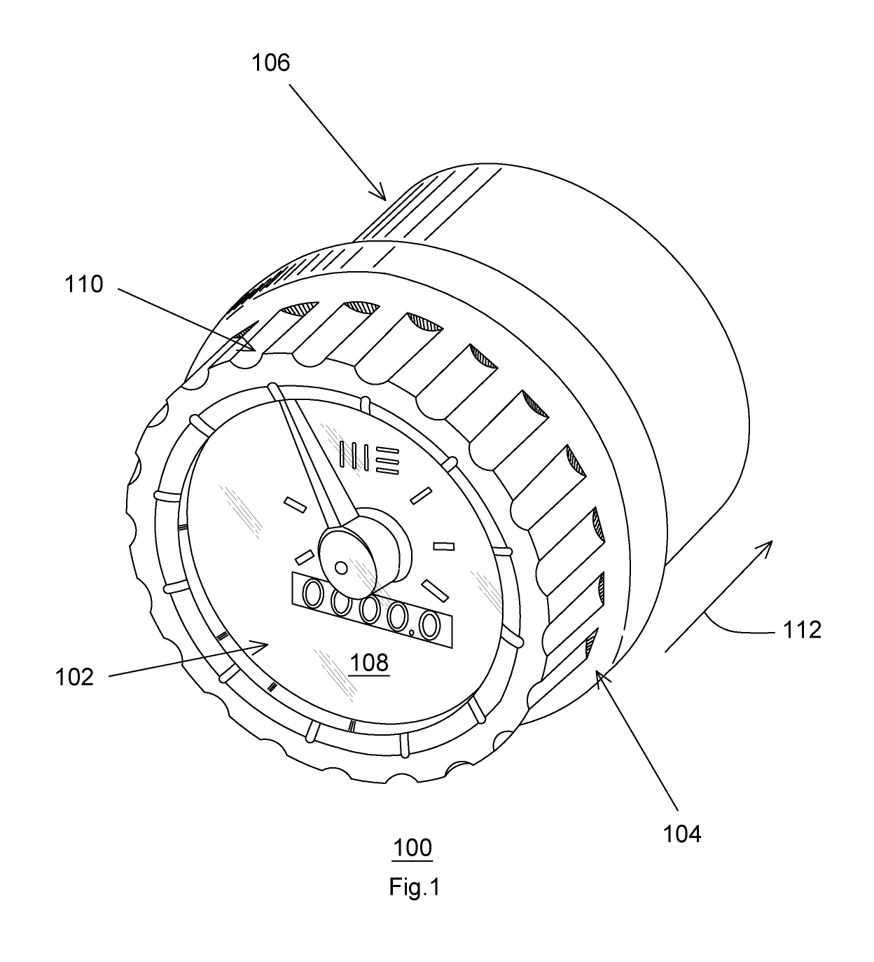

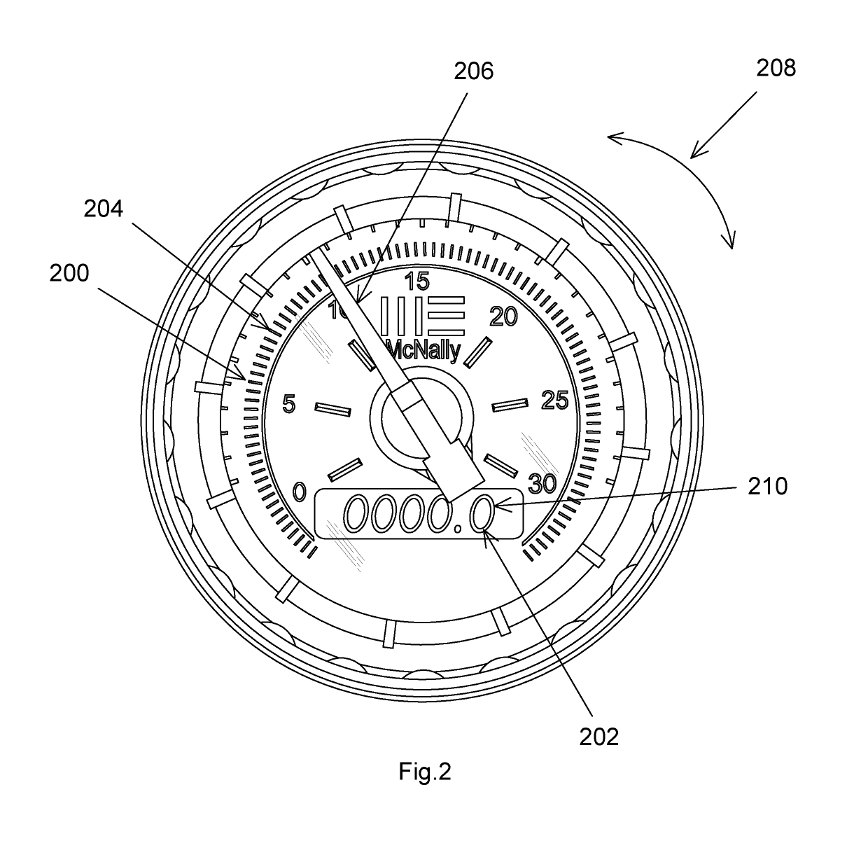

Referring now to FIGS. 1-2, one embodiment of the present invention is shown in a perspective view and a front elevational view. FIGS. 1-2 show several advantageous features of the present invention, but, as will be described below, the invention can be provided in several shapes, sizes, combinations of features and components, and varying numbers and functions of the components. The first example of a rotary gauge 100, as shown in FIGS. 1-2, includes a combination analog-digital instrument display 102, a rotary selector 104, a rear case 106, and a transparent face 108.

In one embodiment, the combination analog-digital instrument display 102 includes both an analog dial 200 and a digital display 202. As used herein, the term “analog dial” is intended to indicate a face, plate, disk, or other surface upon which an analog measurement is registered and/or indicated with graduation markings and at least one pointer or needle. In the depicted embodiment, the analog dial 200 is a physical analog dial with physical markings 204 and a physical pointer 206. As used herein, the term “physical” is intended to differentiate between an element, feature, or device that exists in the real-world as a physical component, as opposed to a digital representation, such as, for example, an electronic display that simulates an analog dial (e.g., used in some aircraft cockpit instrument panels). In one embodiment, the analog dial 200 is a true, physical analog dial, with fixed physical graduation markings and at least one rotatable physical pointer 206. In an alternative embodiment, the analog dial 200 may be a digital representation of an analog dial on an electronic display with a digitally represented pointer and graduation markings. A physical analog dial 200 is preferred as it is generally considered more accurate.

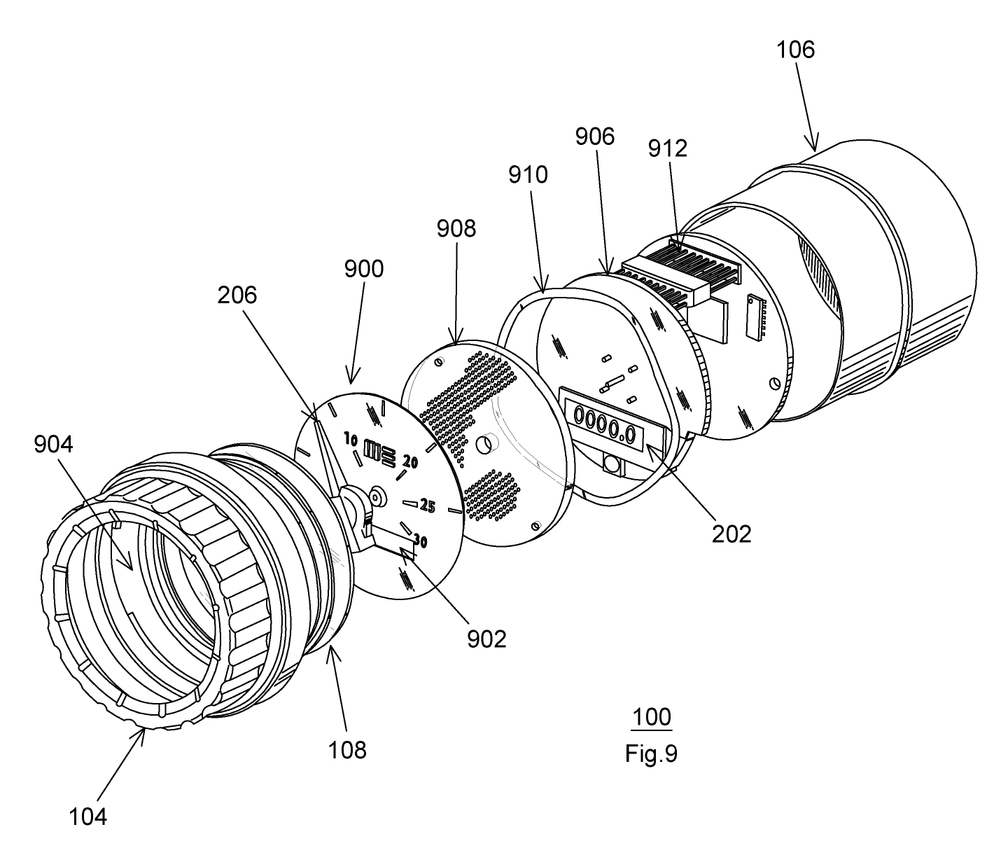

In one embodiment, the analog dial 200 may be formed as a display panel 900 (see FIG. 9) having a generally planar surface on which the physical graduation markings 204 are etched or otherwise imprinted thereon. The analog dial 200 may also define an aperture 902 (see FIG. 9) through which the digital display 202 is viewable. As used herein, the term “viewable” is intended to indicate the ability for the referenced object to be viewed by a vehicle driver seated in a driver's seat of the vehicle after the rotary gauge 100 of the present invention has been installed in the vehicle instrument panel and/or dashboard. In one embodiment, the analog dial 200 may be a custom display panel that is specially ordered from a gauge manufacturer. Advantageously, users may be able to select which sensor readouts they prefer as an analog display and which sensor readouts are acceptable as a digital readout. In another embodiment, the analog dial 200 and the digital display 202 may be unitary, i.e., formed integrally with one another.

In another embodiment, the analog dial 200 may display a physical quantity that is different from a physical quantity displayed by the digital display 202. As used herein, the term “physical quantity” is defined as a physical property of a phenomenon, body, substance, or anything that can be quantified by measurement, especially with a sensor or meter. Such physical quantities are typically expressed as a number and a unit (or combination of units), such as, for example, 60 miles/hour. Exemplary physical quantities, include, but are not limited to pressure, mass, amount of a substance, length, time, temperature, volume, electric current, light intensity, force, velocity, acceleration, density, etc. In an exemplary embodiment, the analog dial 200 may display an exhaust gas temperature, for example, while the digital display 202 displays a water temperature, for example. It should be apparent that a multitude of different physical quantity combinations between the analog dial 200 and the digital display 202 may be utilized in embodiments of the present invention, and may only be limited by the number and type of sensors disposed within a vehicle to measure such physical quantities.

Referring still to FIGS. 1-2, with brief reference to FIG. 9, in one embodiment, the rotary selector 104 may define a central aperture 904. As used herein, the term “rotary selector” is defined as an object with a surface that is graspable/grippable by a user and rotatable by the user so that a degree of rotation corresponds to a selected input. The rotary selector 104 may be considered a rotary knob or a rotary dial. In one embodiment, the rotary selector 104 may include a gripping surface 110. In a further embodiment, the gripping surface 110 may include indentations and/or ribs that provide additional friction to allow the user to more easily grip the gripping surface 110 for rotation. In another embodiment, the gripping surface 110 may be provided with other frictional surfaces. In an alternative embodiment, the rotary selector 104 may be provided with a generally smooth surface.

Preferably, the rotary selector 104 is circular-shaped and the central aperture 904 defined by the rotary selector 104 may also be circular-shaped, with a slightly smaller diameter than a diameter of the rotary selector 104. The central aperture 904 may be considered a through-hole. In an installed configuration of the rotary gauge 100, the rotary selector 104 may frame the combination analog-digital instrument display 102 such that both the analog dial 200 and the digital display 202 are simultaneously viewable through the central aperture 904. In other words, both the analog dial 200 and the digital display 202 can be seen by the driver/user at the same time through the central aperture 904 defined by the rotary selector 104. In one embodiment, the analog dial 200 and/or the digital display 202 are fixed with respect to the rotary selector 104. Stated another way, the rotary selector 104 is rotatable about the combination analog-digital instrument display 102. In one embodiment, the rotary selector 104 is rotatable at least 360 degrees about the combination analog-digital instrument display 102. In another embodiment, the rotary selector 104 is rotatable less than 360 degrees about the combination analog-digital instrument display 102. In yet another embodiment, the rotary selector 104 is rotatable about the combination analog-digital instrument display 102 in a rotational direction 208, i.e., a clockwise and/or a counter-clockwise direction, or both.

In one embodiment, the rotary selector 104 is rotatable about the combination analog-digital instrument display 102 such that a rotation of the rotary selector 104 is operable to change an image 210 displayed on the digital display 202. In another embodiment, a depression of the rotary selector 104, in an axial direction 112, towards the rear, changes the image 210 displayed on the digital display 202. In one embodiment, such rotation and/or depression of the rotary selector 104 may change the image 210 on the digital display 202 in various ways, such as, for example, activating a light to illuminate the image 210, or changing units of the physical quantity from one unit system to another (e.g., Fahrenheit to Celsius). As used herein, the term “digital display” is intended to indicate an electronic display that displays information visually in the form of characters (numbers and/or letters). The digital display 202 may be formed as, for example, an LED display, an LCD display, and the like. In one embodiment, the digital display 202 may be formed as a segment display, including multiple segments that are configured to only display digits or alphanumeric characters. In other embodiments, the digital display 202 may be provided in other forms and configurations.

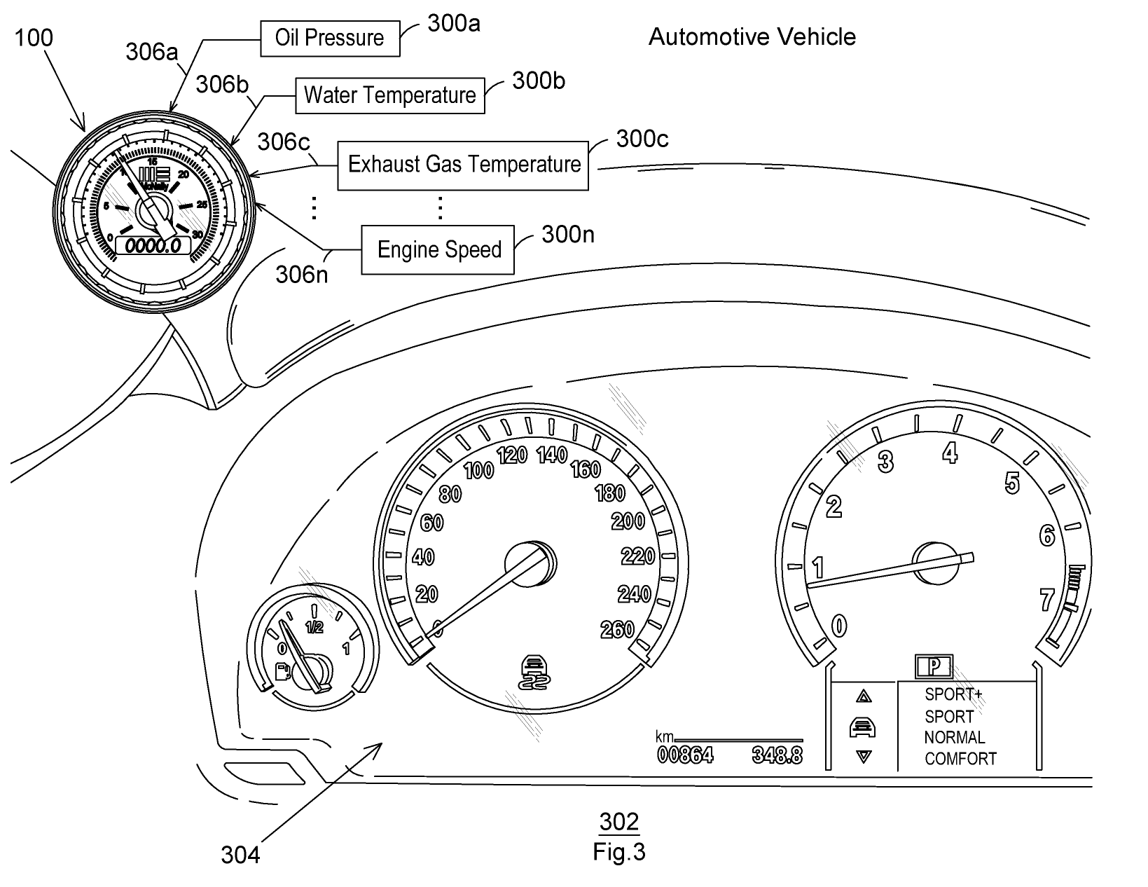

Referring still to FIGS. 1-2, with reference now also to FIGS. 3-7, in another embodiment, such rotation and/or depression of the rotary selector 104 may select, as an input for the digital display 202, one of a plurality of vehicle sensors 300a-n disposed within an automotive vehicle 302 on which the rotary gauge 100 may be mounted. The number of vehicle sensors 300 can be any number from 1 to n, where “n” is any number greater than 1. It should be understood that while all (or at least a portion) of the plurality of vehicle sensors 300a-n are considered “inputs” for the digital display 202, data lines for the vehicle sensors 300 may be routed through a controller, microprocessor, a PCB 906 (see FIG. 9), or other processing device prior to corresponding display data being provided as inputs to the digital display 202. In other words, vehicle sensor 300 outputs are typically first processed through a processing device, such as, the PCB 906, and then input into the digital display 202 to display the data in alphanumeric form for the user to understand.

Referring now to FIG. 3, with reference to FIGS. 1-2, the rotary gauge 100 is communicatively coupled to the plurality of sensors 300. In the exemplary embodiment depicted in FIG. 3, the rotary gauge 100 is coupled to an oil pressure sensor 300a, a water temperature sensor 300b, an exhaust gas temperature sensor 300c, and an engine speed sensor 300n. Each of the plurality of sensors 300a-n measures a different physical quantity associated with the automotive vehicle 302 (e.g., water temperature, temperature of exhaust gas, oil pressure, and engine speed). It should be understood that there are a multitude of types of vehicle sensors that can be disposed within the automotive vehicle 302. As used herein, the term “vehicle sensor” is defined as a device disposed within or on a vehicle that detects or measures a physical quantity associated with the vehicle and records, indicates, outputs, or otherwise responds to it.

The rotary gauge 100 may be installed within, on, or proximate an instrument display panel 304 of the automotive vehicle 302. In one embodiment, the rotary gauge 100 is installed on the pre-existing instrument display panel 304 provided by the vehicle manufacturer. This may require replacement of an existing gauge with the inventive rotary gauge 100 of the present invention. In another embodiment, the rotary gauge 100 may be installed within another portion of the dashboard that is not occupied by any pre-existing gauges. In yet another embodiment, the rotary gauge 100 may be installed within yet another area within the automotive vehicle 302.

In one embodiment, there may be at least one conductor 306a-n (e.g., electrical wire(s), cable, etc.) communicatively/electrically coupling each respective vehicle sensor 300a-300n to the rotary gauge 100. The number of conductors 306a-n can be any number from 1 to n, where “n” is any number greater than 1. The conductors 306 can be considered data lines, transmitting sensor readout data to the rotary gauge 100. In one embodiment, one of the data lines may be routed to control the pointer 206 in the analog dial 200, while the remaining data lines may be dedicated to the digital display 202. As explained above, the output of the digital display 202 can be selected by the user with the rotary selector 104. In a further embodiment, at least one of the conductors 306 may be a power line and at least another of the conductors 306 may be a ground line.

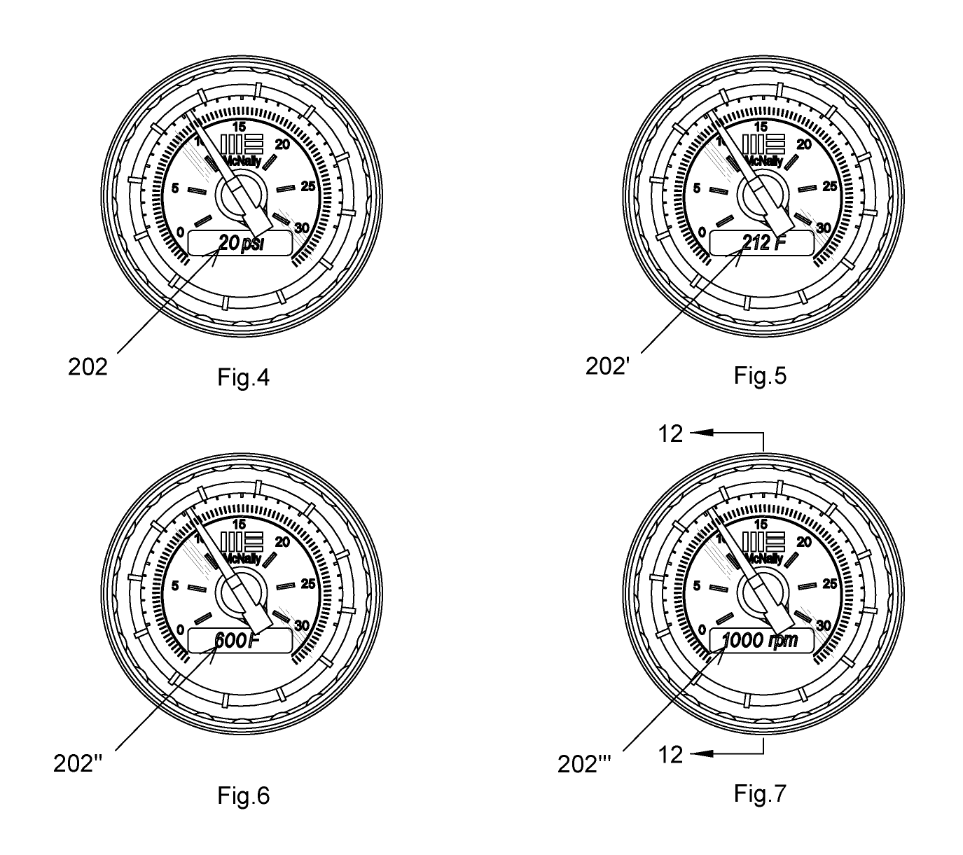

FIGS. 4-7 show the combination analog-digital instrument display 102 at various instances in time. In particular, FIGS. 4-7 illustrate user selection (via rotation and/or depression of the rotary selector 104) of each of the plurality of vehicle sensors 300a-n and a resulting display of the corresponding physical quantity on the digital display 202. As an illustrative example, FIG. 4 depicts the digital display 202 displaying data from the vehicle sensor 300a. FIG. 5 depicts the digital display 202 displaying data from the vehicle sensor 300b. FIG. 6 depicts the digital display 202 displaying data from the vehicle sensor 300c. And, FIG. 7 depicts the digital display 202 displaying data from the vehicle sensor 300n. Advantageously, by providing an inventive rotary gauge 100 that allows users to selectively switch-out sensor readings from various vehicle sensors 300, users can save on dashboard/instrument panel space; yet, still be able to view sensor readings from a virtually unlimited number of vehicle sensors 300. This can also assist users with self-repair and self-maintenance efforts, because, in some embodiments, users may be enabled with the ability to view all (or a substantial portion) of the vehicle sensors 300 within a single gauge. Prior art self-repair/maintenance efforts typically require specialized equipment only readily available to vehicle dealerships and auto repair shops to read the various codes transmitted by electrical sensors disposed within most new vehicles.

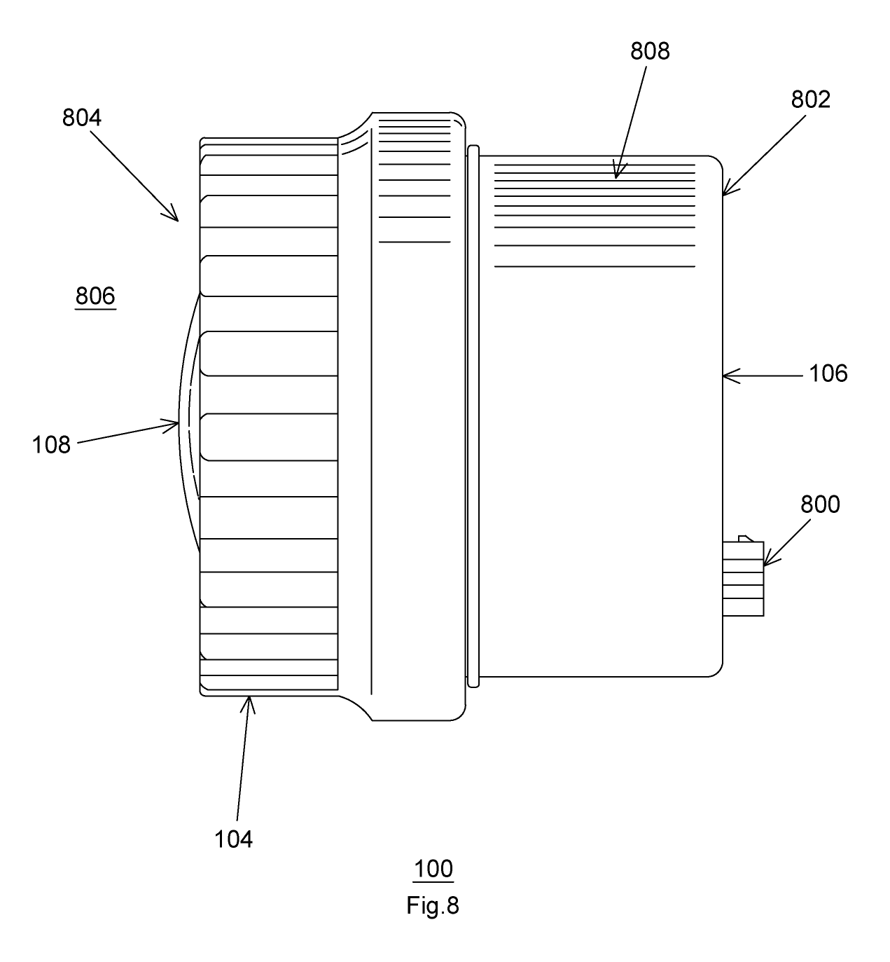

Referring now to FIG. 8, with reference to FIG. 3, in one embodiment, a universal connector 800 may be disposed on a rear face 802 of the rotary gauge 100. The universal connector 800 may be operably configured to electrically couple the rotary gauge 100 to each of the plurality of vehicle sensors 300 disposed within the automotive vehicle 302. The universal connector 800 may be formed as a male connector, in one embodiment, and a female connector, in another embodiment. The universal connector 800 may be formed as a friction-fit type connector to its mating connector. In one embodiment, the universal connector 800 may be formed as a snap-fit connector. The universal connector 800 may be considered an electro-mechanical device for joining electrical components/circuits as an interface using a mechanical assembly. Unlike prior art gauges that require installers to manually couple individual wires, the universal connector 800 may allow installers/users to quickly electrically couple the rotary gauge 100 to the plurality of vehicle sensors 300 via a quick and easy plug-in action with a single mating connector.

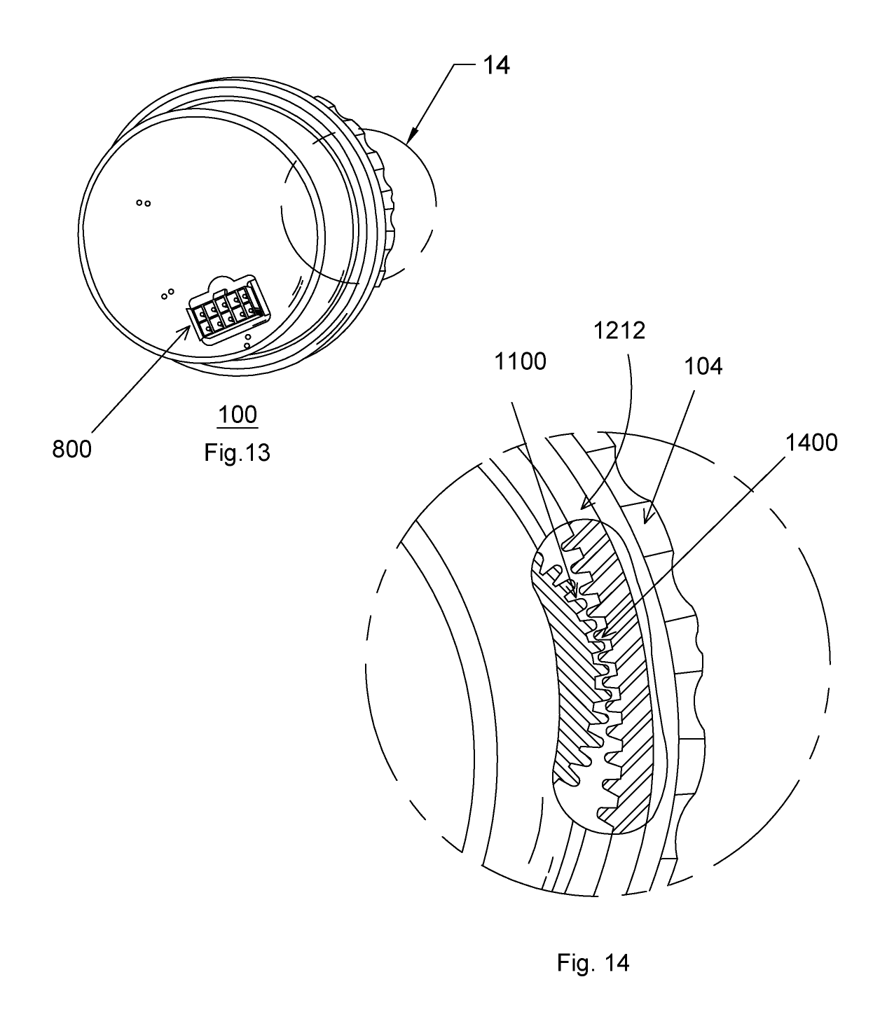

Referring now briefly to FIG. 13, the universal connector 800 is shown in a partial, rear view of the rotary gauge 100. The universal connector 800 may be formed as a multi-pin connector for power and data lines. In one embodiment, the universal connector 800 is formed as a 10-pin connector. In other embodiments, the universal connector 800 may include more or less than 10 pins. In use, the user may connect the rotary gauge 100 to the plurality of vehicle sensors 300 (not shown) in a single step by simply plugging-in a mating connector to the universal connector 800. Advantageously, installation of the rotary gauge 100 may be greatly simplified. In other embodiments, the rotary gauge 100 may be provided without the universal connector 800.

Referring again to FIG. 8, with reference to FIG. 1, in one embodiment, the rotary gauge 100 may include an outer housing 804 that substantially encloses the combination analog digital-instrument display 102 therein from an outside environment 806. As used herein, the term “substantially encloses” is intended to indicate that the outer housing 804 provides an enclosure on all sides, which may or may not include one or more nominal openings, such as, for example, one or more openings for a fastener and/or an opening for the universal connector 800. The outer housing 804 may include the rotary selector 104, in addition to the rear case 106 and the transparent face 108, which may together form the outer housing 804. The rear case 106 may include a cylindrical sidewall 808 in addition to the rear face 802. The rear case 106 may be made of any material, such as, for example, a plastic or other polymer-based material. The rear case 106 may be configured to mechanically couple to the rotary selector 104 to form a seal or other firm attachment. The transparent face 108 may be formed as a lens and may be made of any transparent material, such as, for example, glass or a transparent polymer-based material. The transparent face 108 allows users to view the combination analog digital-instrument display 102 from the outside environment 806, while also protecting the display 102 from the outside environment 806. Preferably, the transparent face 108 is made of a shatter-proof material, such as a shatter-proof glass material. Advantageously, the enclosure provided by the outer housing 804 may seal and protect the display 102 and other electrical, mechanical, and optical components therein from the outside environment 806.

Referring now to FIG. 9, the rotary gauge 100 is shown in an exploded view. In one embodiment, the rotary gauge 100 may include the rotary selector 104, the transparent face 108, the analog display panel 900, a light display member 908, a balancing member 910, the digital display 202, the PCB 906 (formed as a dual-PCB), and the rear case 106. In further embodiments, there may be additional components/devices not shown in FIG. 9. The rotary gauge 100 depicted in FIG. 9 is merely exemplary and it should be understood that the invention is not intended to be limited to this particular embodiment.

Because the rotary selector 104, the transparent face 108, and the digital display 202 were discussed herein above, the other components 900, 908, 910, 906 identified in FIG. 9 will now be discussed herein below.

The analog display panel 900 may be considered a permanent display providing an analog output that is not selectable/changeable on-the-fly, as with the digital display 202. In one embodiment, the user may select the analog read-out prior to the actual manufacturing of the rotary gauge 100, during an ordering process. Accordingly, the user may select the analog read-out according to sensor data frequently relied upon by the user, such as, for example, speed, or engine temperature. The analog display panel 900 may include graduation markings common in analog displays etched or otherwise imprinted on its surface. The analog display panel 900 may also be associated with an analog pointer, such as the pointer 206.

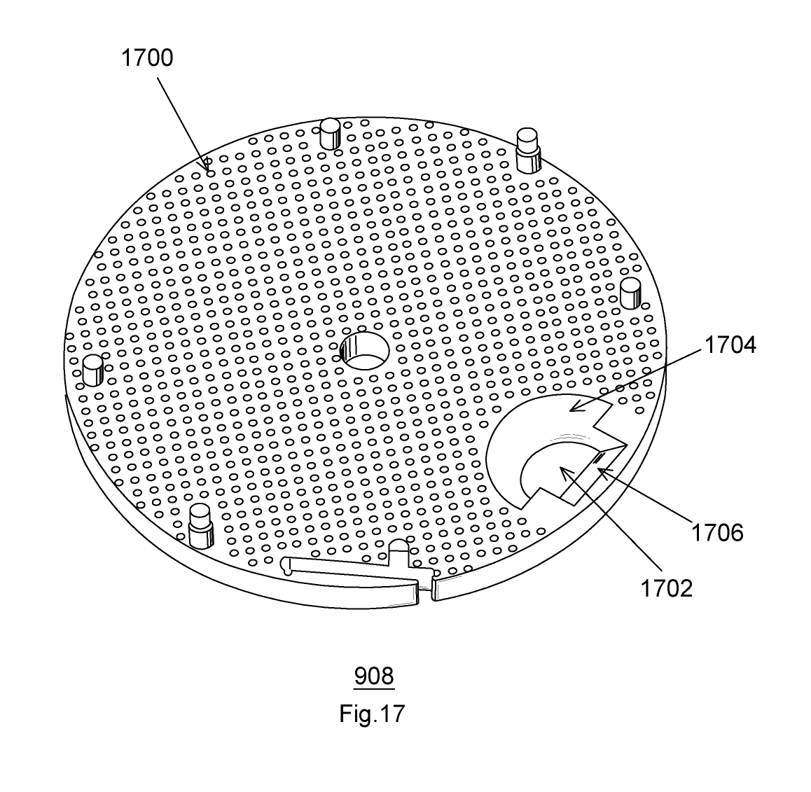

The light display member 908 may be considered a transparent or semi-transparent substrate. The light display member 908 may be shaped, in some embodiments, as a disk, and may be operably configured to maximize light disbursement of light traveling through the transparent face 108. Referring briefly to FIG. 17, the light display member 908 may be made of a polymer-based material. In another embodiment, the light display member 908 may be made of a glass material. In yet another embodiment, the light display member 908 may be made of another type of transparent or semi-transparent material. In one embodiment, the light display member 908 may include a plurality of dome-shaped bubbles 1700 operably configured to enhance light travel through the transparent face 108. In one embodiment, the light display member 908 may define an aperture 1702 through which light may travel. In a further embodiment, the light display member 908 may include at least one perimeter surface 1704 circumscribing the aperture 1702 that is oriented at an angular direction in order to deflect light towards the aperture 1702. In yet a further embodiment, the perimeter surface 1704 may be oriented at a 45 degree angle relative to an imaginary plane defined by an outer-most perimeter of the light display member 908. In another embodiment, the light display member 908 may include a second perimeter surface 1706 that is also oriented at an angular direction to reflect light towards the aperture. The second perimeter surface 1706 may be oriented at a 45 degree angle relative to the imaginary plane. In other embodiments, the perimeter surface 1704 may be angularly oriented outside of this range.

Referring again to FIG. 9, the balancing member 910 may be made of a resilient material, such as a foam spring material, and may be operably configured to provide balance to the rotary selector 104 during a push and/or rotational movement thereof. The balancing member 910 may be generally circular-shaped. In a further embodiment, the balancing member 910 may be shaped as a circular wave. In other words, the circumference of the balancing member 910 may follow a slightly wavy path, as illustrated in FIG. 9.

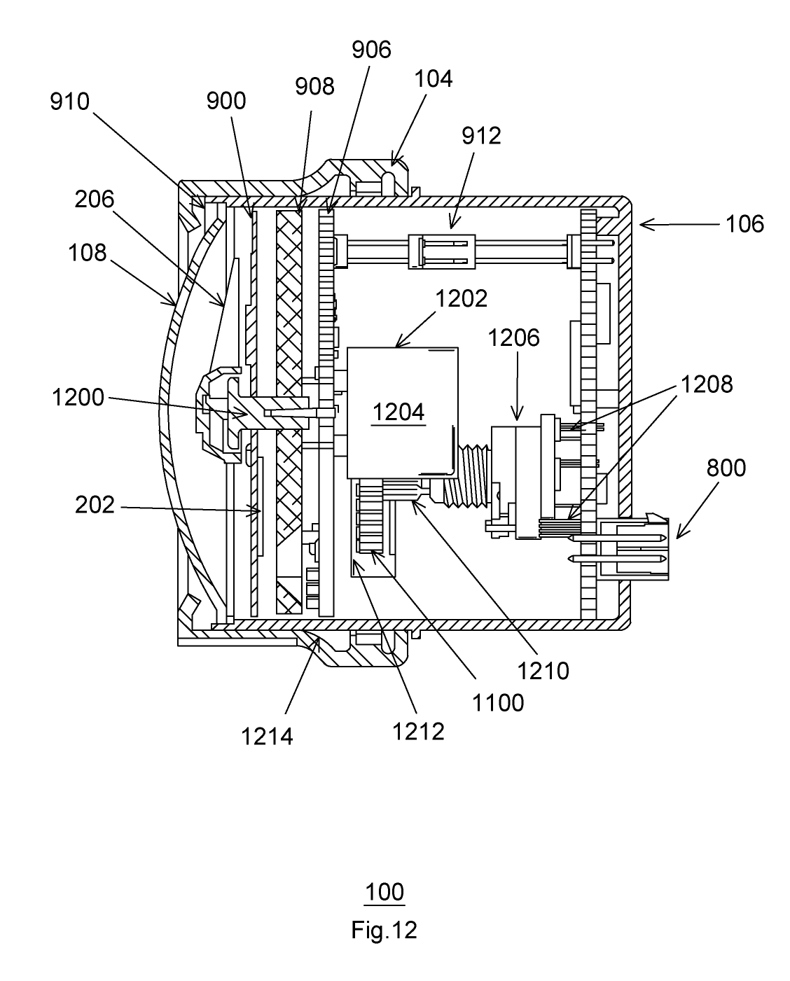

The PCB 906 is at least one printed circuit board that mechanically supports and electrically connects electric components associated with the rotary gauge 100. In the exemplary embodiment, the PCB 906 is formed as a dual-PCB with two printed circuit boards connected together by a bridge of conductor pins 912. The exemplary PCB 906 will be described in more detail with reference to the cross-sectional view depicted in FIG. 12 below.

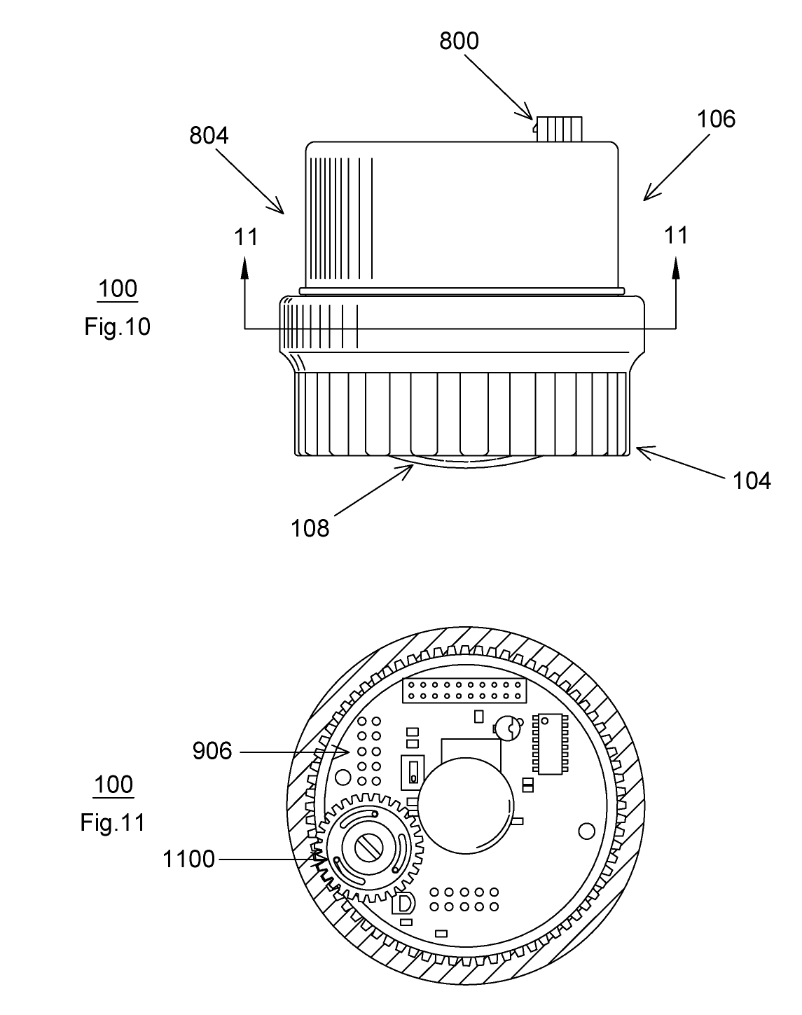

Referring now to FIGS. 10-11, the rotary gauge 100 is shown in a top view and a cross-sectional view, respectively. FIG. 10 illustrates the rotary selector 104, the rear case 106, and the transparent face 108 forming the outer housing 804 and providing the universal connector 800 disposed on the rear case 106. FIG. 11 illustrates a portion of the PCB 906 on which electrical components associated with the rotary gauge 100 are mechanically supported and electrically coupled together. In one embodiment, a rotary gear 1100 may be mechanically coupled to the PCB 906. The rotary gear 1100 may be formed as any type of gear, such as, for example, a bevel gear, a spur gear, a helical gear, and the like. The rotary gear 1100 may be included in a rotary encoder that converts an angular position of the rotary selector 104 into a digital signal, allowing the user to select a sensor output according to rotation/depression of the rotary selector 104. The exemplary rotary encoder is described in more detail herein with reference to FIG. 12 below.

Referring now to FIG. 12, with reference to FIG. 3, a cross-sectional side view of the exemplary rotary gauge 100 is shown, illustrating an exemplary arrangement of the components of the rotary gauge, showing the rear case 106, the rotary selector 104, the light display member 908, the transparent face 108, the balancing member 910, and the analog display panel 900.

Internal components associated with the analog dial 200 (see FIG. 2) will now be described. The rotary gauge 100 may include a rotary shaft 1200 fixedly coupled to the analog pointer 206. In another embodiment, the rotary gauge 100 may include a first rotary encoder 1202. FIG. 12 depicts a first rotary encoder housing 1204 that substantially encloses supporting components for the analog dial 200 (see FIG. 2). In a further embodiment, the housing 1204 may enclose therein components for an analog encoder (e.g., potentiometer). Such supporting components may include, but is not limited to, a digital-to-analog converter (DAC) and at least one gear (not shown). The DAC may be communicatively coupled to the PCB 906, which may transmit data signals from the vehicle sensor 300 transmitting sensor output for the analog dial 200. Such vehicle sensors 300 may be referred to in the art as the “sending unit” for the corresponding gauge display. The data signals may be converted, by the DAC, from electrical data signals to corresponding analog signals that may cause the gear (not shown) to rotate. As the gear may be fixedly coupled to the pointer 206, rotation of the gear may drive rotation of the pointer 206 according to the data from the sending unit. Electrical signals may be transmitted from the sending unit via the universal connector 800 from the first portion of the PCB 906 across the conductor pin bridge 912 to the second portion of the PCB 906. In alternative embodiments, the PCB 906 may include only a single PCB board configuration devoid of the conductor pin bridge 912.

To implement the selectable, digital display 202 portion of the combination analog-digital instrument display 102, a second rotary encoder 1206 may be included in the rotary gauge 100. In a preferred embodiment, the second rotary encoder 1206 may be formed as an optical encoder 1206. Sensor output from the vehicle sensors 300 may be transmitted to the rotary gauge 100, via the universal connector 800. More specifically, sensor output from the vehicle sensors 300 may be transmitted to the PCB 906 via sensor data pins 1208. One of the pins may provide power to the optical encoder 1206. As is known in the art, optical encoders typically include an opaque disk defining a plurality of slits (not shown). A lighting element emits light through the slits, which may be detected by at least one photosensor. The opaque disk (not shown) may be fixedly coupled to a rotary shaft 1210 that is also fixedly coupled to the rotary gear 1100. As the rotary gear 1100 is rotated causing the opaque disk (not shown) to rotate, the photosensor(s) may detect the resulting optical pattern from the opaque disk's position. A microprocessor, microcontroller, or other processing device (not shown) may be able to determine the angle of the rotary shaft 1210. Such angular position may be used to determine a user selection of one of the plurality of vehicle sensors 300 to be displayed on the digital display 202.

In one embodiment, the rear case 106 may define an aperture (or cut-out) 1212 through which teeth (or other protruding element) of the rotary gear 1100 are exposed to an interior surface 1214 of the rotary selector 104. In other words, the teeth of the rotary gear 1100 may be disposed within an area between the interior surface 1214 of the rotary selector 104 and an exterior surface of the rear case 106. Stated yet another way, a portion of the rotary gear 1100 (i.e., a portion of the teeth) extends outwardly through the aperture 1212 and is disposed exterior to the rear case 106. In particular, the teeth of the rotary gear 1100 may be shaped to matingly engage mating gear teeth 1400 disposed on the interior surface 1214 of the rotary selector 104, which can be more clearly seen in FIGS. 13-14. In use, the user may rotate the rotary selector 104 in order to select a sensor output to be displayed on the digital display 202. As a result, the mating gear teeth 1400 causes the rotary gear 1100 to rotate, which, in turn, causes the rotary shaft 1210 to rotate, thereby activating selection of the sensor output via the optical encoder 1206. The PCB 906 may convert output from the optical encoder 1206 into digital signals for displaying sensor output in a human-readable form (e.g., numerical values) on the digital display 202. In further embodiments, some user selections made via the rotary selector 104 may not include changing a sensor output, but may instead be related to how the data is displayed (e.g., changing the lighting of the digital display 202 or the measurement units, etc.). In alternative embodiments, the second rotary encoder 1206 for the digital display 202 may be provided as another type of rotary encoder known in the art.

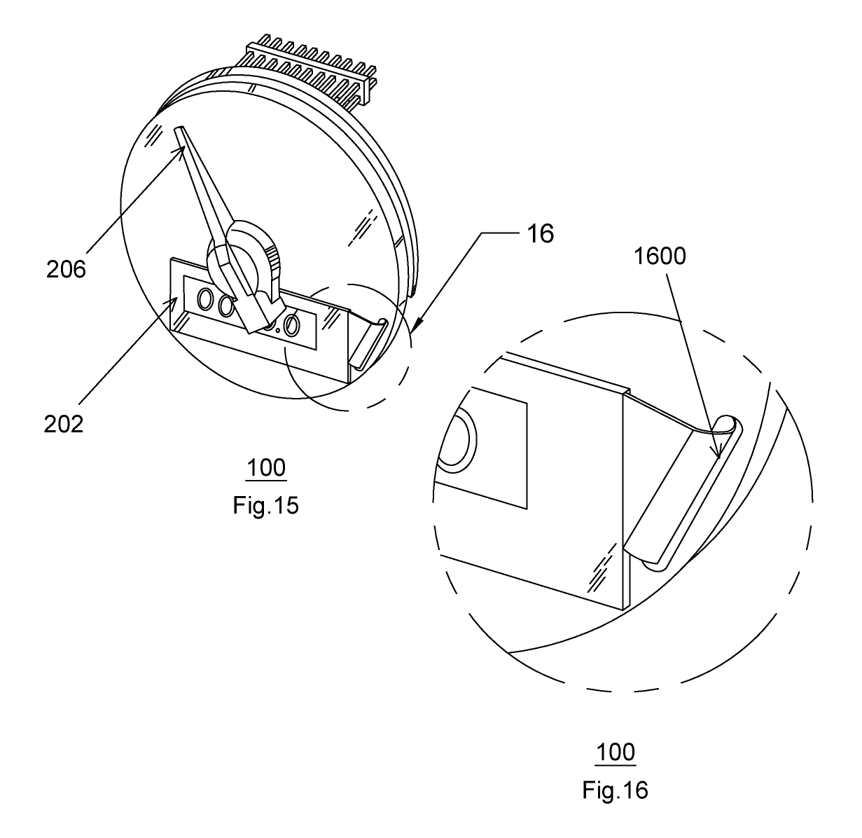

Referring to FIGS. 15-16, a portion of the rotary gauge 100 is illustrated showing the digital display 202 and the analog pointer 206. In one embodiment, a slot 1600 may be formed for engagement with the light display member 908 (see FIG. 9), which may be disposed rearward of the digital display 202.

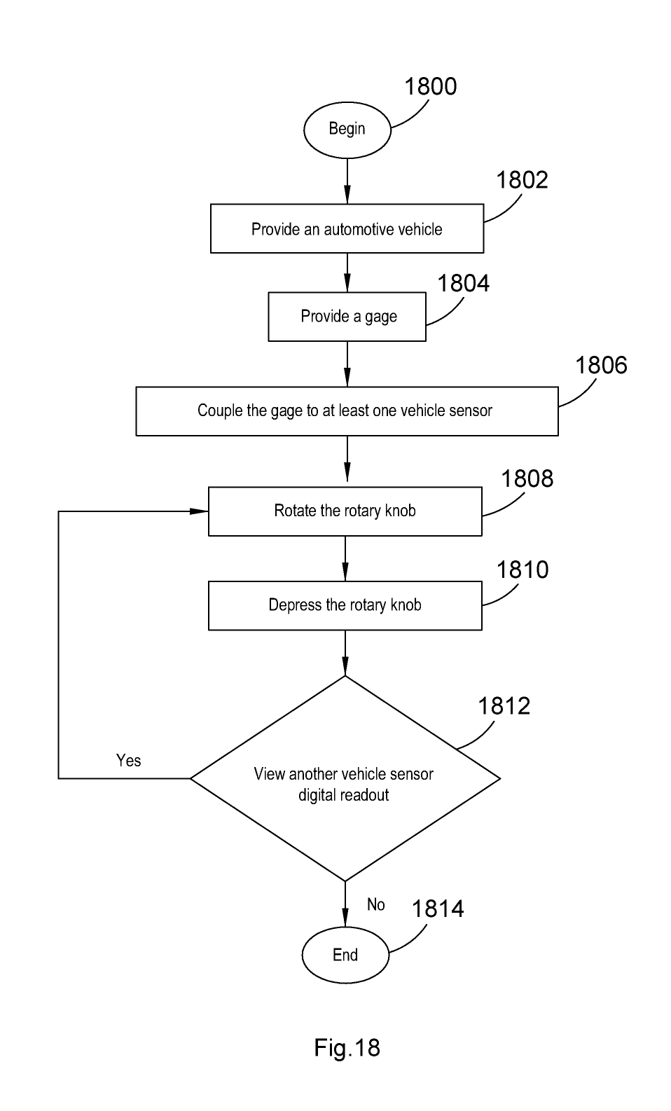

The process flow chart of FIG. 18 will be described with reference to FIGS. 1-3 and FIGS. 8-9. Although FIG. 18 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 18 for the sake of brevity. In some embodiments, some or all of the process steps included in FIG. 18 can be combined into a single process.

In the exemplary embodiment, the process may be considered an aftermarket gauge installation process by the owner/user of the automotive vehicle 302. However, other embodiments may include a process performed by a vehicle manufacturer to install the inventive rotary gauge 100. The process may begin with step 1800 and immediately proceed to step 1802, where the user provides the automotive vehicle 302 with the plurality of vehicle sensors 300 disposed therein. In one embodiment, all or a portion of the plurality of vehicle sensors 300 may be provided by the vehicle manufacturer during the manufacturing process. In other words, the vehicle sensors 300 may be pre-existing vehicle sensors. In another embodiment, all or a portion of the plurality of vehicle sensors 300 may be installed in the automotive vehicle 302 by the user aftermarket according to know methods of installing aftermarket sensors in automotive vehicles.

In step 1804, the user may provide the rotary gauge 100. The rotary gauge 100 may include the combination analog-digital instrument display 102 with the analog dial 200 and the digital display 202. The rotary gauge 100 may also include the rotary selector 104, which defines the central aperture 904 and also frames the combination analog-digital instrument display 102 such that both the analog dial 200 and the digital display 202 are simultaneously viewable through the central aperture 904.

In step 1806, the user may couple the rotary gauge 100 to each of the plurality of vehicle sensors 300. Of course, there may be additional vehicle sensors 300 within the automotive vehicle 302 that are not coupled to the rotary gauge 100, because, for example, the user may not be concerned with reading the output for such sensors. In one embodiment, the user may couple the rotary gauge 100 to each of the plurality of vehicle sensors 300 by plugging a sensor connector into the universal connector 800, which may be disposed on the rear face 802. This may be, for example, a snap connection, a friction-fit type connection, or other electro-mechanical configurations. In one embodiment, the universal connector 800 may include a plurality of conductor pins operable to electrically and mechanically couple to mating conductor pins on the sensor connector. In one embodiment, the user may couple the rotary gauge 100 to a vehicle dashboard. In another embodiment, the user may couple the rotary gauge 100 to an instrument panel. In yet other embodiments, the user may couple the rotary gauge 100 to other areas of the automotive vehicle 302 from which the driver can view the readouts on the rotary gauge 100, while driving. In one embodiment, the user may couple the rotary gauge 100 to at least three vehicle sensors 300 (one for the analog dial 200 and the other two for the digital display 202). In another embodiment, the user may couple the rotary gauge 100 to less than three vehicle sensors 300 or more than three vehicle sensors 300.

In step 1808, the user may rotate the rotary selector 104 about the combination analog-digital instrument display 102 in either a clockwise or counter-clockwise direction. In one embodiment, rotation of the rotary selector 104 may actuate the optical encoder 1206 that is electro-mechanically coupled to the rotary selector 104 so as to allow the user to select one of the plurality of vehicle sensors 300 as the input for the digital display 202. In other embodiments, the rotary selector 104 may be implemented with other types of rotary encoders, such as, for example, a potentiometer or a magnetic encoder. As is known in the art, rotary encoders are considered to be an electro-mechanical (and sometimes optical) device that converts angular position or motion of a shaft into a corresponding analog or digital signal. Rotary encoders may be absolute or incremental.

In step 1810, the user may depress the rotary selector 104 in the axial direction 112 to select, as an input for the digital display 202, one of the plurality of vehicle sensors 300. Such rotation and depression allows the user to switch out images on the digital display 202 to display a user-selected physical quantity associated with a corresponding vehicle sensor 300. In other words, the user may selectively display a physical quantity measured by a selected vehicle sensor 300. Subsequently, in step 1812, the user may desire the ability to view a physical quantity measured by another vehicle sensor 300, different from the vehicle sensor selected in step 1810. If the user desires to select another vehicle sensor 300, the user may return to step 1808, where the user may again rotate and depress the rotary selector 104 at a different position to select yet another vehicle sensor 300. Stated another way, the user may display a second physical quantity different from the first physical quantity on the digital display 202 by rotating and depressing the rotary selector 104 to select a second vehicle sensor 300 that measures the second physical quantity. If the user does not desire to view the readout of another vehicle sensor 300, the process may proceed to step 1814, where the process immediately ends.

A novel and efficient gauge with a rotary selector knob has been disclosed that allows users to selectively change the images on the digital display. Embodiments of the invention provide for a combination analog-digital gauge that includes both an analog dial and a digital display that are both simultaneously viewable within the gauge. In addition, embodiments of the invention provide that the rotary selector knob frames both the analog dial and the digital display and the rotary selector knob is rotatable about the analog dial-digital display. Further, in some embodiments, depression of the rotary selector knob in an axial direction may actuate an optical encoder that selects, as an input for the digital display, one of a plurality of vehicle sensors disposed within the vehicle for measures different physical quantities associated with the automotive vehicle (e.g., pressure, temperature, speed, acceleration, distance, etc.). In yet further embodiments, the gauge includes a universal connector disposed on a rear face of the gauge that allows users to more conveniently and safely electrically couple the gauge to the vehicle sensors in a single step (e.g., a snap connector, male-female connector, or other friction-fit type connector that easily snaps or connects to a mating connector coupled to a vehicle sensor). In yet another embodiment, the gauge is entirely sealed within its housing, with the exception of the opening for the universal connector.

What is claimed is:

1. A rotary gauge, the gauge comprising:
a combination analog-digital instrument display including an analog dial and a digital display; and
a rotary selector:
defining a central aperture;
framing the combination analog-digital instrument display such that both the analog dial and the digital display are simultaneously viewable through the central aperture; and
rotatable about the combination analog-digital instrument display such that at least one of a rotation and a depression of the rotary selector changes a physical quantity displayed on the digital display.

2. The gauge in accordance with claim 1, wherein:
the at least one of the rotation and the depression of the rotary selector selects, as an input for the digital display, one of a plurality of vehicle sensors disposed within an automotive vehicle and communicatively coupled to the gauge, each of the plurality of vehicle sensors measuring a different physical quantity associated with the automotive vehicle.

3. The gauge in accordance with claim 2, further comprising:
a universal connector disposed on a rear face of the gauge and operably configured to electrically couple the gauge to each of the plurality of vehicle sensors disposed within the automotive vehicle.

4. The gauge in accordance with claim 3, wherein:
the universal connector is formed as at least one of a male connector and a female connector.

5. The gauge in accordance with claim 1, wherein:
the analog dial displays a physical quantity different from a physical quantity displayed by the digital display.

6. The gauge in accordance with claim 1, further including:
an optical encoder actuated by the at least one of the rotation and the depression of the rotary selector so as to allow a user to select one of a plurality of vehicle sensors as an input for the digital display.

7. The gauge in accordance with claim 1, further comprising:
an outer housing that substantially encloses the combination analog-digital instrument display therein, the outer housing including the rotary selector.

8. The gauge in accordance with claim 1, wherein:
the analog dial includes fixed physical graduation markings and at least one rotatable physical pointer.

9. A rotary gauge comprising:
a combination analog-digital instrument display including an analog dial and a digital display;
a rotary selector defining a central aperture and framing the combination analog-digital instrument display such that both the analog dial and the digital display are simultaneously viewable through the central aperture; and
a universal connector disposed on a rear face of the gauge and operably configured to electrically couple the gauge to each of a plurality of vehicle sensors disposed within an automotive vehicle.

10. The gauge in accordance with claim 9, wherein:
each of the plurality of vehicle sensors measures a different physical quantity associated with the automotive vehicle; and
the rotary selector is rotatable about the combination analog-digital instrument display such that at least one of a rotation and a depression of the rotary selector selects, as an input for the digital display, one of the plurality of vehicle sensors.

11. The gauge in accordance with claim 10, further including:
an optical encoder actuated by the at least one of the rotation and the depression of the rotary selector so as to allow a user to select one of the plurality of vehicle sensors as the input for the digital display.

12. The gauge in accordance with claim 9, wherein:
the universal connector is formed as at least one of a male connector and a female connector.

13. The gauge in accordance with claim 9, wherein:
the analog dial displays a physical quantity different from a physical quantity displayed by the digital display.

14. The gauge in accordance with claim 9, further comprising:
an outer housing that substantially encloses the combination analog-digital instrument display therein, the outer housing including the rotary selector.

15. A method of installing a gauge in an automotive vehicle, the method comprising steps of:
providing, by a user, an automotive vehicle including a plurality of vehicle sensors;
providing, by the user, a gauge including:
a combination analog-digital instrument display with an analog dial and a digital display, and
a rotary selector defining a central aperture and framing the combination analog-digital instrument display such that both the analog dial and the digital display are simultaneously viewable through the central aperture; and
coupling, by the user, the gauge to each of the plurality of vehicle sensors by plugging a vehicle connector into a universal connector disposed on a rear face of the gauge.

16. The method in accordance with claim 15, wherein the step of coupling further includes a step of:
coupling, by the user, the gauge to at least one of a vehicle dashboard and an instrument panel of the automotive vehicle.

17. The method in accordance with claim 15, further comprising steps of:
rotating, by the user, the rotary selector about the combination analog-digital instrument display; and
depressing, by the user, the rotary selector in an axial direction to select, as an input for the digital display, one of the plurality of vehicle sensors so that a first physical quantity measure by the one of the plurality of vehicle sensors is displayed on the digital display.

18. The method in accordance with claim 17, further comprising a step of:
displaying, by the user, a second physical quantity different from the first physical quantity on the digital display by at least one of rotating and depressing the rotary selector to select a second one of the plurality of vehicle sensors that measures the second physical quantity.

19. The method in accordance with claim 17, where the step of rotating, by the user, further comprising a step of:
actuating, by the user, an optical encoder electro-mechanically coupled to the rotary selector so as to allow the user to select one of the plurality of vehicle sensors as the input for digital display.

20. The method in accordance with claim 15, wherein the step of coupling, by the user, further includes a step of:
coupling, by the user, the gauge to at least three vehicle sensors disposed within the automotive vehicle.
